(19) United States
(12) Patent Application Publication
(10) Pub. No.: US 2009/0061274 A1
(43) Pub. Date: Mar. 5, 2009

(54) DIRECT ALCOHOL FUEL CELLS USING SOLID ACID ELECTROLYTES

(75) Inventors: Sossina M. Haile, Altadena, CA (US); Tetsuya Uda, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA (US)

(21) Appl. No.: 12/205,489

(22) Filed: Sep. 5, 2008

Related U.S. Application Data
(63) Continuation of application No. 11/095,464, filed on Mar. 30, 2005, now abandoned.
(60) Provisional application No. 60/557,522, filed on Mar. 30, 2004.

(51) Int. Cl. H01M 4/38

(52) U.S. Cl. 429/29; 429/32

(57) ABSTRACT

Direct alcohol fuel cells using solid acid electrolytes and internal reforming catalysts are disclosed. The fuel cell generally comprises an anode, a cathode, a solid acid electrolyte and an internal reforming catalyst. The internal reforming catalyst may comprise any suitable reformer and is positioned adjacent the anode. In this configuration the heat generated by the exothermic fuel cell catalyst reactions and ohmic heating of the fuel cell electrolyte drives the endothermic fuel reforming reaction, reforming the alcohol fuel into hydrogen. Any alcohol fuel may be used, e.g. methanol or ethanol. The fuel cells according to this invention show increased power density and cell voltage relative to direct alcohol fuel cells not using an internal reformer.

### CROSS-REFERENCES TO RELATED APPLICATIONS

This application is a continuation of U.S. application Ser. No. 11/095,464, filed Mar. 30, 2005, which claims the benefit of Provisional Application Ser. No. 60/557,522, filed Mar. 30, 2004, entitled DIRECT ALCOHOL FUEL CELLS USING SOLID ACID ELECTROLYTES, the entire disclosures of which are incorporated herein by reference.

### STATEMENT AS TO RIGHTS TO INVENTIONS MADE UNDER FEDERALLY SPONSORED RESEARCH AND DEVELOPMENT

The United States government has certain rights in this invention pursuant to Grant No. DMR-9902882, awarded by the National Science Foundation, and Grant No. N00014-02-1-0192, awarded by the Office of Naval Research.

### REFERENCE TO A “SEQUENCE LISTING,” A TABLE, OR A COMPUTER PROGRAM LISTING APPENDIX SUBMITTED ON A COMPACT DISK

NOT APPLICABLE

### FIELD OF THE INVENTION

The invention is directed to direct alcohol fuel cells using solid acid electrolytes.

### BACKGROUND OF THE INVENTION

Alcohols have recently been heavily researched as potential fuels. Alcohols, such as methanol and ethanol, are particularly desirable as fuels because they have energy densities five- to seven-fold greater than that of standard compressed hydrogen. For example, one liter of methanol is energetically equivalent to 5.2 liters of 350 atm-compressed hydrogen. Also, one liter of ethanol is energetically equivalent to 7.2 liters of 350 atm-compressed hydrogen. Such alcohols are also desirable because they are easily handled, stored and transported.

Methanol and ethanol have been the subject of much of the alcohol fuel research. Ethanol can be produced by the fermentation of plants containing sugar and starch. Methanol can be produced by the gasification of wood or wood/cereal waste (straw). Methanol synthesis, however, is more efficient. These alcohols, among others, are renewable resources, and are therefore expected to play an important role both in reducing greenhouse gas emissions and in reducing dependence on fossil fuels.

Fuel cells have been proposed as devices for converting the chemical energy of such alcohols into electric power. In this regard, direct alcohol fuel cells having polymer electrolyte membranes have been heavily researched. Specifically, direct methanol fuel cells and direct ethanol fuel cells have been studied. However, research into direct ethanol fuel cells has been limited due to the relative difficulty in ethanol oxidation compared to methanol oxidation.

Despite these vast research efforts, the performance of direct alcohol fuel cells remains low, primarily due to kinetic limitations imparted by the electrode catalysts. For example, a typical direct methanol fuel cell exhibits a power density of about 50 mW/cm.sup.2. Higher power densities, e.g. 335 mW/cm.sup.2, have been obtained, but only under extremely severe conditions (NAFIONR®, 130° C., 5 atm oxygen and 1 M methanol with a flow of 2 cc/min under a pressure of 1.8 atm). Similarly, a direct ethanol fuel cell exhibited a power density of 110 mW/cm.sup.2 under similar extremely severe conditions (NAFION®-silica, 140° C., 4 atm anode, 5.5 atm oxygen). Accordingly, a need exists for direct alcohol fuel cells having high power densities in the absence of such extreme conditions.

### SUMMARY OF THE INVENTION

The present invention is directed to alcohol fuel cells having solid acid electrolytes and using an internal reforming catalyst. The fuel cell generally comprises an anode, a cathode, a solid acid electrolyte, and an internal reformer. The reformer reforms the alcohol fuel into hydrogen. This reforming reaction is driven by the heat generated by the exothermic fuel cell reactions.

The use of solid acid electrolytes in the fuel cell enable the reformer to be placed immediately adjacent to the anode. This was not previously thought possible due to the elevated temperatures required for known reforming materials to function efficiently and the sensitivity of typical polymer electrolyte membranes to heat. However, the solid acid electrolytes can withstand much higher temperatures than the typical polymer electrolyte membranes, enabling the placement of the reformer adjacent the anode and therefore close to the electrolyte. In this configuration, the waste heat generated by the electrolyte is absorbed by the reformer and powers the endothermic reforming reaction.

### BRIEF DESCRIPTION OF THE DRAWINGS

These and other features and advantages of the present invention will be better understood by reference to the following detailed description when considered in conjunction with the accompanying drawings, wherein:

FIG. 1 is a schematic depicting a fuel cell according to one embodiment of the present invention;

FIG. 2 is a graphical comparison of the power density and cell voltage curves of the fuel cells prepared according to Examples 1 and 2 and Comparative Example 1;

FIG. 3 is a graphical comparison of the power density and cell voltage curves of the fuel cells prepared according to Examples 3, 4 and 5 and Comparative Example 2; and

FIG. 4 is a graphical comparison of the power density and cell voltage curves of the fuel cells prepared according to Comparative Examples 2 and 3.

### DETAILED DESCRIPTION

The present invention is directed to direct alcohol fuel cells having solid acid electrolytes and utilizing an internal reforming catalyst in physical contact with the membrane-electrode assembly (MEA) for reforming the alcohol fuel into hydrogen. As noted above, the performance of fuel cells that convert the chemical energy in alcohols directly to electric power remains low due to kinetic limitations of the fuel cell electrode catalysts. However, it is well known that these kinetic limitations are greatly reduced when hydrogen fuel is used. Accordingly, the present invention uses a reforming catalyst, or reformer, to reform the alcohol fuel into hydrogen, thereby reducing or eliminating the kinetic limitations associated with the alcohol fuel. Alcohol fuels are steam reformed according to the following exemplary reactions:

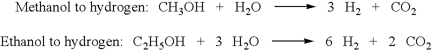

The reforming reaction, however, is highly endothermic. Therefore, to drive the reforming reaction, the reformer must be heated. The heat required is typically about 59 kJ per mol methanol (equivalent to combustion of about 0.25 mol hydrogen) and about 190 kJ per mol of ethanol (equivalent to combustion of about 0.78 mol hydrogen).

The passage of current during operation of fuel cells generates waste heat, the efficient removal of which has proven problematic. The generation of this waste heat, however, makes placement of the reformer directly beside the fuel cell a natural choice. Such a configuration enables the reformer to supply the fuel cell with hydrogen and cool the fuel cell, and allows the fuel cell to heat and power the reformer. Molten carbonate fuel cells and methane reforming reactions operating at a temperature of about 650° C. have employed such a configuration. However, alcohol reforming reactions generally take place at temperatures ranging from about 200° C. to about 350° C., and no suitable alcohol reforming fuel cell has yet been developed.

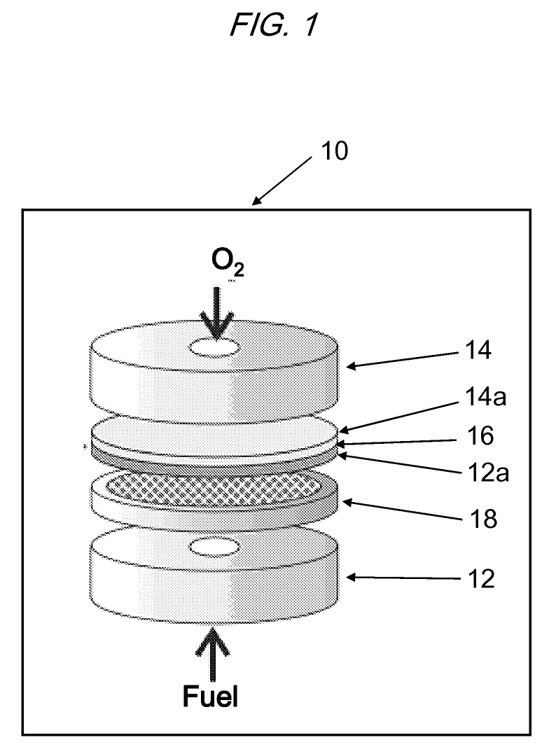

The present invention is directed to such an alcohol reforming fuel cell. As illustrated in FIG. 1, the fuel cell 10 according to the present invention generally comprises a first current collector/gas diffusion layer 12, an anode 12a, a second current collector/gas diffusion layer 14, a cathode 14a, an electrolyte 16 and an internal reforming catalyst 18. The internal reforming catalyst 18 is positioned adjacent the anode 12a. More specifically, the reforming catalyst 18 is positioned between the first gas diffusion layer 12 and the anode 12a. Any known, suitable reforming catalyst 18 can be used. Nonlimiting examples of suitable reforming catalysts include Cu—Zn—Al oxide mixtures, Cu—Co—Zn—Al oxide mixtures and Cu—Zn—Al—Zr oxide mixtures.

Any alcohol fuel can be used, such as methanol, ethanol and propanol. In addition, dimethyl ether may be used as the fuel.

Historically, this configuration was not thought possible for alcohol fuel cells due to the endothermic nature of the reforming reaction and the heat sensitivity of the electrolyte. Typical alcohol fuel cells use polymer electrolyte membranes which cannot withstand the heat needed to power the reforming catalyst. However, the electrolytes used in the fuel cells of the present invention comprise solid acid electrolytes, such as those described in U.S. Pat. No. 6,468,684, entitled PROTON CONDUCTING MEMBRANE USING A SOLID ACID, the entire contents of which are incorporated herein by reference, and in co-pending U.S. patent application Ser. No. 10/139,043, entitled PROTON CONDUCTING MEMBRANE USING A SOLID ACID, the entire contents of which are also incorporated herein by reference. One nonlimiting example of a suitable solid acid for use as an electrolyte with the present invention is CsH₂PO₄. The solid acid electrolytes used with the fuel cells of this invention can withstand much higher temperatures, enabling placement of the reforming catalyst immediately adjacent the anode. Moreover, the endothermic reforming reaction consumes the heat produced by the exothermic fuel cell reactions, creating a thermally balanced system.

These solid acids are used in their superprotonic phases and work as proton conducting membranes over a temperature range of from about 100° C. to about 350° C. The upper end of this temperature range is ideal for methanol reformation. To ensure that enough heat is generated to drive the reforming reaction, and to ensure that the solid acid electrolyte conducts protons, the fuel cell of the present invention is preferably operated at temperatures ranging from about 100° C. to about 500° C. More preferably, however, the fuel cell is operated at temperatures ranging from about 200° C. to about 350° C. In addition to significantly improving the performance of alcohol fuel cells, the relatively high operation temperatures of the inventive alcohol fuel cells may enable replacement of precious metal catalysts, such as Pt/Ru and Pt at the anode and cathode, respectively, with less costly catalyst materials.

The following Examples and Comparative Examples illustrate the superior performance of the inventive alcohol fuel cells. However, these Examples are presented for illustrative purposes only, and are not to be construed as limiting the invention to these Examples.

### EXAMPLE 1

### Methanol Fuel Cell

13 mg/cm² Pt/Ru was used as the anode electrocatalyst. Cu(30 wt %)-Zn(20 wt %)-Al was used as the internal reforming catalyst. 15 mg/cm² Pt was used as the cathode electrocatalyst. A 160 μm thick membrane of CsH₂PO₄ was used as the electrolyte. Vaporized methanol and water mixtures were supplied to the anode chamber at a flow rate of 100 μl/min. 30% humidified oxygen was supplied to the cathode at a flow rate of 50 cm³/min (STP). The methanol:water ratio was 25:75. The cell temperature was set at 260° C.

### EXAMPLE 2

### Ethanol Fuel Cell

13 mg/cm² Pt/Ru was used as the anode electrocatalyst. Cu(30 wt %)-Zn(20 wt %)-Al was used as the internal reforming catalyst. 15 mg/cm² Pt was used as the cathode electrocatalyst. A 160 μm thick membrane of CsH₂PO₄ was used as the electrolyte. Vaporized ethanol and water mixtures were supplied to the anode chamber at a flow rate of 100 μl/min. 30% humidified oxygen was supplied to the cathode at a flow rate of 50 cm³/min (STP). The ethanol:water ratio was 15:85. The cell temperature was set at 260° C.

### COMPARATIVE EXAMPLE 1

### Pure H₂Fuel Cell

13 mg/cm² Pt/Ru was used as the anode electrocatalyst. 15 mg/cm² Pt was used as the cathode electrocatalyst. A 160 μm thick membrane of CsH₂PO₄ was used as the electrolyte. 3% humidified hydrogen was supplied to the anode chamber at a flow rate of 100 μl/min. 30% humidified oxygen was supplied to the cathode at a flow rate of 50 cm³/min (STP). The cell temperature was set at 260° C.

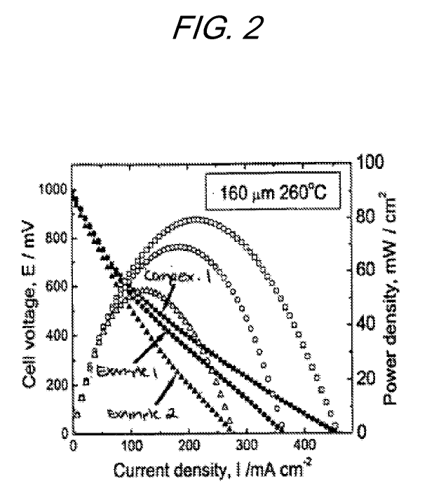

FIG. 2 shows the power density and cell voltage curves of Examples 1 and 2 and Comparative Example 1. As shown, the methanol fuel cell (Example 1) achieved a peak power density of 69 mW/cm², the ethanol (Example 2) fuel cell achieved a peak power density of 53 mW/cm², and the hydrogen fuel cell (Comparative Example 1) achieved a peak power density of 80 mW/cm². These results show that the fuel cells prepared according to Example 1 and Comparative Example 1 are very similar, indicating that the methanol fuel cell with the reformer performs nearly as well as the hydrogen fuel cell, a substantial improvement. However, further increases in power density are achieved by reducing the thickness of the electrolyte, as shown in the below Examples and Comparative Examples.

### EXAMPLE 3

A fuel cell was fabricated by slurry deposition of CsH₂PO₄ onto a porous stainless steel support, which served both as a gas diffusion layer and a current collector. The cathode electrocatalyst layer was first deposited onto the gas diffusion layer and then pressed, prior to deposition of the electrolyte layer. The anode electrocatalyst layer was subsequently deposited, followed by placement of the second gas diffusion electrode as the final layer of the structure.

A mixture of CsH₂PO₄, Pt (50 atomic wt %) Ru, Pt (40 mass %)-Ru (20 mass %) supported on C (40 mass %) and naphthalene was used as the anode electrode. The mixing ratio of CsH₂PO₄:Pt—Ru:Pt—Ru—C:naphthalene was 3:3:1:0.5 (by mass). A total mixture of 50 mg was used). The Pt and Ru loadings were 5.6 mg/cm² and 2.9 mg/cm², respectively. The area of the anode electrode was 1.74 cm².

A mixture of CsH₂PO₄, Pt, Pt (50 mass %) supported on C (50 mass %) and naphthalene was used as the cathode electrode. The mixing ratio of CsH₂PO₄:Pt:Pt—C:naphthalene was 3:3:1:1 (by mass). A total mixture of 50 mg was used. The Pt loadings were 7.7 mg/cm². The area of the cathode was 2.3-2.9 cm².

CuO (30 wt %)-ZnO(20 wt %)-Al₂O₃, i.e. CuO (31 mol %)-ZnO (16 mol %)-Al₂O₃, was used as the reforming catalyst. The reforming catalyst was prepared by a co-precipitation method using a copper, zinc and aluminum nitrate solution (total metal concentration was 1 mol/L), and an aqueous solution of sodium carbonates (1.1 mol/L). The precipitate was rinsed with deionized water, filtered and dried in air at 120° C. for 12 hours. The dried powder of 1 g was lightly pressed to a thickness of 3.1 mm and a diameter of 15.6 mm, and then calcined at 350° C. for 2 hours.

A 47 μm thick CsH₂PO₄ membrane was used as the electrolyte.

A methanol-water solution (43 vol % or 37 mass % or 25 mol % or 1.85 M methanol) was fed through a glass vaporizer (200° C.) at a rate of 135 μl/min. The cell temperature was set at 260° C.

### EXAMPLE 4

A fuel cell was prepared according to Example 3 above except that an ethanol-water mixture (36 vol % or 31 mass % or 15 mol % or 0.98 M ethanol), rather than a methanol-water mixture was fed through the vaporizer (200° C.) at a rate of 114 μl/min.

### EXAMPLE 5

A fuel cell was prepared according to Example 3 above except that vodka (Absolut Vodka, Sweden)(40 vol % or 34 mass % or 17 mol % ethanol) instead of the methanol-water mixture was fed at a rate of 100 μl/min.

### COMPARATIVE EXAMPLE 2

A fuel cell was prepared according to Example 3 above except that dried hydrogen of 100 sccm humidified through hot water (70° C.) was used instead of the methanol-water mixture.

### COMPARATIVE EXAMPLE 3

A fuel cell was prepared according to Example 3 above except that no reforming catalyst was used and the cell temperature was set at 240° C.

### COMPARATIVE EXAMPLE 4

A fuel cell was prepared according to Comparative Example 2, except that the cell temperature was set at 240° C.

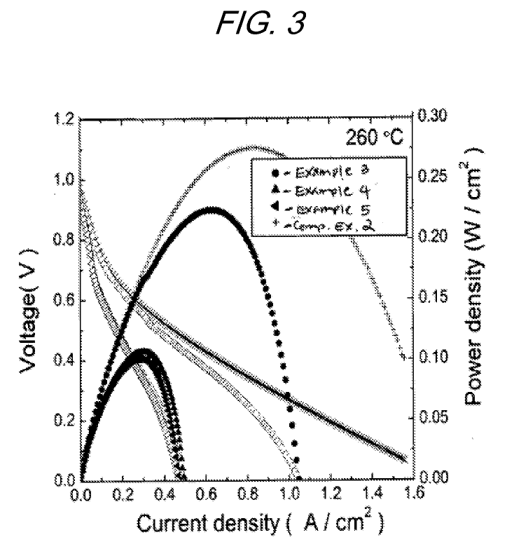

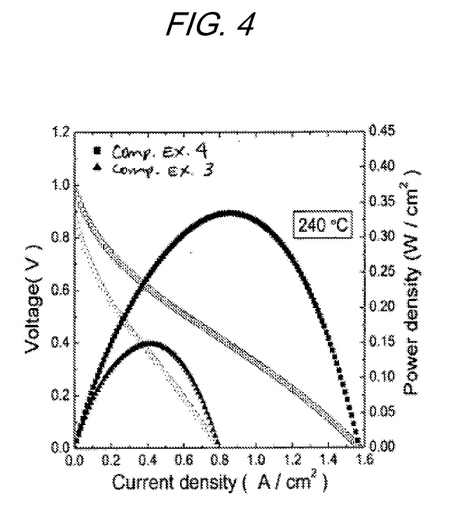

FIG. 3 shows the power density and cell voltage curves of Examples 3, 4 and 5 and Comparative Example 2. As shown, the methanol fuel cell (Example 3) achieved a peak power density of 224 mW/cm², a substantial increase in power density over the fuel cell prepared according to Example 1 having the much thicker electrolyte. This methanol fuel cell also shows dramatically increased performance compared to methanol fuel cells not using an internal reformer, as better shown in FIG. 4. The ethanol fuel cell (Example 4) also shows increased power density and cell voltage relative to the ethanol fuel cell having the thicker electrolyte membrane (Example 2). However, as shown, the methanol fuel cell (Example 3) performs better than the ethanol fuel cell (Example 4). The vodka fuel cell (Example 5) achieved power densities comparable to that of the ethanol fuel cell. As shown in FIG. 3, the methanol fuel cell (Example 3) performs nearly as well as the hydrogen fuel cell (Comparative Example 2).

FIG. 4 shows the power density and cell voltage curves of Comparative Examples 3 and 4. As shown, the methanol fuel cell without a reformer (Comparative Example 3) achieved power densities significantly less than those achieved by the hydrogen fuel cell (Comparative Example 4). Also, FIGS. 2, 3 and 4 show that the methanol fuel cells with reformers (Examples 1 and 3) achieve power densities significantly greater than the methanol fuel cell without the reformer (Comparative Example 3).

The preceding description has been presented with reference to the presently preferred embodiments of the invention. Workers skilled in the art and technology to which this invention pertains will appreciate that alterations and modifications may be made to the described embodiments without meaningfully departing from the principal, spirit and scope of this invention. Accordingly, the foregoing description should not be read as pertaining only to the precise embodiments described, but rather should be read as consistent with, and as support for, the following claims, which are to have their fullest and fairest scope.

What is claimed is:

1. A fuel cell comprising:
an anode electrocatalyst layer;
a cathode electrocatalyst layer;
an electrolyte layer comprising a solid acid;
a gas diffusion layer; and
an internal reforming catalyst positioned adjacent the anode electrocatalyst layer such that the internal reforming catalyst is in physical contact with the anode electrocatalyst layer and the internal reforming catalyst is positioned between the anode electrocatalyst layer and the gas diffusion layer.

2. A fuel cell according to claim 1, wherein the solid acid electrolyte comprises CsH₂PO₄.

3. A fuel cell according to claim 1, wherein the reforming catalyst is selected from the group consisting of Cu—Zn—Al oxide mixtures, Cu—Co—Zn—Al oxide mixtures and Cu—Zn—Al—Zr oxide mixtures.

4-25. (canceled)

26. A fuel cell according to claim 1, wherein the gas diffusion layer is a first gas diffusion layer and the fuel cell further comprises a second gas diffusion layer.

27. A fuel cell according to claim 3, wherein the reforming catalyst is a Cu—Zn—Al oxide mixture.

28. A fuel cell according to claim 3, wherein the reforming catalyst is a Cu—Co—Zn—Al oxide mixture.

29. A fuel cell according to claim 3, wherein the reforming catalyst is a Cu—Zn—Al—Zr oxide mixture.

30. A fuel cell according to claim 1, wherein the reforming catalyst is further in thermal contact with the anode electrocatalyst layer.

31. A fuel cell according to claim 1, further comprising a fuel.

32. A fuel cell according to claim 31, wherein the fuel is an alcohol.

33. A fuel cell according to claim 31, wherein the fuel is a member selected from the group consisting of methanol, ethanol, propanol and dimethyl ether.

34. A fuel cell according to claim 1, wherein the fuel cell is operated at a temperature ranging from about 100° C. to about 500° C.

35. A fuel cell according to claim 1, wherein the fuel cell is operated at a temperature ranging from about 200° C. to about 350° C.

36. A fuel cell according to claim 1, comprising
the gas diffusion layer which is a first gas diffusion layer;
the anode electrocatalyst layer;
the internal reforming catalyst selected from the group consisting of Cu—Zn—Al oxide mixtures, Cu—Co—Zn—Al oxide mixtures and Cu—Zn—Al—Zr oxide mixtures, wherein the internal reforming catalyst is positioned adjacent the anode electrocatalyst layer such that the internal reforming catalyst is in physical and thermal contact with the anode electrocatalyst layer and the internal reforming catalyst is positioned between the anode electrocatalyst layer and the first gas diffusion layer;
the electrolyte layer comprising a solid acid comprising CsH₂PO₄;
the cathode electrocatalyst layer;
a second gas diffusion layer; and
a fuel selected from the group consisting of methanol, ethanol, propanol and dimethyl ether, wherein the fuel cell is operated at a temperature ranging from about 100° C. to about 500° C.
